(19) United States
(12) Patent Application Publication
(10) Pub. No.: US 2026/0330789 A1
(43) Pub. Date: Oct. 22, 2026

(54) TEXT-BASED SCENE GENERATION USING ARTIFICIAL INTELLIGENCE MODELS

(71) Applicant: NVIDIA Corporation, Santa Clara, CA (US)

(72) Inventors: Zhaoshuo LI, Santa Clara, CA (US); Chen-Hsuan LIN, Campbell, CA (US); Tsung-Yi LIN, Sunnyvale, CA (US); Yifeng DING, Mountain View, CA (US); Yu ZENG, San Jose, CA (US); Yichen SHENG, San Jose, CA (US); Yunhao GE, Santa Clara, CA (US); Ming-Yu LIU, San Jose, CA (US); Lu LING, West Lafayette, IN (US)

(21) Appl. No.: 19/355,871

(22) Filed: Oct. 10, 2025

Related U.S. Application Data
(60) Provisional application No. 63/790,034, filed on Apr. 17, 2025.

(51) Int. Cl. G06T 19/20; G06T 17/00

(52) U.S. Cl. CPC G06T 19/20; G06T 17/00; G06T 2219/2016

(57) ABSTRACT

In various examples, methods for generating images using generative artificial intelligence models include receiving an input prompt specifying a three-dimensional scene to be generated using one or more generative artificial intelligence models; generating, using a first generative artificial intelligence model, a description of the three-dimensional scene, the description including at least an enumeration of objects to be included in the scene and a description of an arrangement of the objects to be included in the scene; generating, using a second generative artificial intelligence model and the description of the three-dimensional scene, an image representing the three-dimensional scene; iteratively adjusting positioning of one or more objects in the generated image; and outputting the generated image including the adjusted positioning of the one or more objects.

### CROSS-REFERENCE TO RELATED APPLICATIONS

This application claims priority to and benefit of U.S. Provisional Patent Application Ser. No. 63/790,034, entitled “Text-Based Scene Generation Using Language and Visual Language Models,” filed Apr. 17, 2025, and assigned to the assignee hereof, the entire contents of which are hereby incorporated by reference.

### TECHNICAL FIELD

Embodiments of the present disclosure relate generally to computer vision, and more specifically to techniques for generating three-dimensional scenes using generative artificial intelligence models.

### BACKGROUND

Generative artificial intelligence models, such as diffusion models, allow for the generation of visual content—often according to an input prompt that defines a desired scene. The visual content may be, for example, a three-dimensional environment or a simulated three-dimensional environment including objects that are typically included in the desired scene. These models may be trained to generate scenes based on a training data set of a wide variety of three-dimensional environments. In turn, these three-dimensional scenes may be used in a variety of downstream tasks, particularly in serving as training data for training machine learning models to perform complex tasks such as navigation, object manipulation (e.g., in robotics), and the like. Because three-dimensional scenes can be used to train machine learning models to perform real-world tasks, ensuring that three-dimensional scenes are realistic and physically possible is highly important.

Generally, techniques for generating three-dimensional scene data that can be used to train a machine learning model involve manual design or other resource- and time-intensive techniques. Procedural approaches have also been used to generate three-dimensional scene data; however, these approaches do not generate realistic and physically plausible three-dimensional scene data that can be used to train a machine learning model. Finally, autoregressive machine learning model techniques can also be used to generate three-dimensional scene data; however, the scenes generated by autoregressive models are often constrained by the limited amount of data that is available to train an autoregressive model, and these models may not be able to generalize beyond spatial relationships embodied in the data. Thus, these models may be limited to generating scenes without complex dependencies between different objects in such a scene.

As the foregoing illustrates, what is needed in the art are more effective techniques for using generative artificial intelligence models to generate a wide variety of three-dimensional scenes.

### BRIEF DESCRIPTION OF DRAWINGS

FIG. 1 illustrates a block diagram of a computing system configured to implement one or more aspects of at least one embodiment;

FIG. 2 illustrates a pipeline for generating realistic and physically plausible three-dimensional scenes based on a language model and a visual model, according to at least one embodiment;

FIG. 3 illustrates example operations for generating realistic and physically plausible three-dimensional scenes based on a language model and a visual model, according to at least one embodiment;

FIG. 4A illustrates inference and/or training logic, according to at least one embodiment;

FIG. 4B illustrates inference and/or training logic, according to at least one embodiment; and

FIG. 5 illustrates training and deployment of a neural network, according to at least one embodiment.

### DETAILED DESCRIPTION

As discussed, the generation of three-dimensional scene data can be used in a variety of tasks, such as training machine learning models for controlling automobiles, robots, or other physical devices in a real-world environment. Because scene data can be used to train machine learning models to perform actions within the real world, it is important for the scene data to include realistic scenes and realistic arrangements of objects in the scenes. For example, a scene should include objects in physically plausible locations, such as objects stacked directly on top of each other versus objects suspended in space. Additionally, because real-world laws of physics dictate that multiple objects cannot occupy the same location in space, the arrangement of objects in generated three-dimensional scene data should obey these laws.

While generative artificial intelligence models are able to generate scenes according to an input prompt, the scenes generated by these models are often unrealistic. For example, due to limitations in the variety of scenes included in a training data set used to train these generative artificial intelligence models, such models may result in limited diversity in the scenes generated by the models. Examples of this limited diversity may include the generation of scenes in which objects are arranged at right angles or in parallel with each other, even though the objects in a realistic scene may be positioned at any angle relative to another object. For scenes generated using language and vision models, objects may be associated with bounding boxes that restrict how these models place objects within a scene. These bounding boxes may, however, limit how objects are arranged in a scene. For example, these bounding boxes may restrict the ability to stack or otherwise arrange objects (e.g., such that only objects smaller than a base object can be placed on top of a base object), leading to difficulties in arranging items inside of constrained spaces, such as shelves or the like. Finally, visual models such as diffusion models may allow for the generation of scenes with spatial realism; however, because these models may generate a scene as a monolithic construct, object-level interaction may not be possible.

To improve the ability of generative artificial intelligence models to generate realistic three-dimensional scenes, embodiments of the present disclosure provide techniques for using language models and vision models to generate three-dimensional scenes in response to an input prompt. Generally, a language model can be used to generate a list of objects included in a scene and generate an upsampled prompt that specifies the scene and spatial relationships between objects in the scene. This upsampled prompt may be input into a vision model, which generates an intermediate scene according to the upsampled prompt. The intermediate scene can be used to generate a scene graph representing the objects in the scene, and adjustments to the positioning of objects in the scene can be performed based on the scene graph. By doing so, embodiments of the present disclosure may allow for the generation of three-dimensional scene data that is spatially coherent and physics-aware (physically realistic). These scenes may, for example, comply with rules restricting or preventing an excess amount of overlap between objects in the same space and other physics and spatial rules for a scene while increasing the diversity of scenes generated by a generative artificial intelligence model. For example, scenes may reflect a variety of plausible arrangements of objects instead of arrangements of objects in which objects are located parallel with other objects or perpendicular with other objects. Because embodiments of the present disclosure can generate a diverse range of scenes that can be used to train machine learning models, embodiments of the present disclosure may improve the ability of computer vision systems to perform various actions in a real-world environment based on desired or undesired interactions between objects in a real-world environment.

The above examples are not in any way intended to be limiting. As persons skilled in the art will appreciate, as a general matter, the techniques for automatically generating dialogue flows from unlabeled conversation data can be implemented in any suitable application.

The systems and methods described herein may be used for a variety of purposes, by way of example and without limitation, for use in systems associated with machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., an infotainment or plug-in gaming/streaming system of an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as large language models (LLMs), vision language models (VLMs), and/or multi-modal language models that may process text, audio, and/or image data, systems for performing light transport simulation, systems for performing collaborative content creation for 3D assets (e.g., systems or platforms that use universal scene descriptor (USD) data, such as OpenUSD), systems implemented at least partially using cloud computing resources, systems for performing generative AI operations, and/or other types of systems.

### System Overview

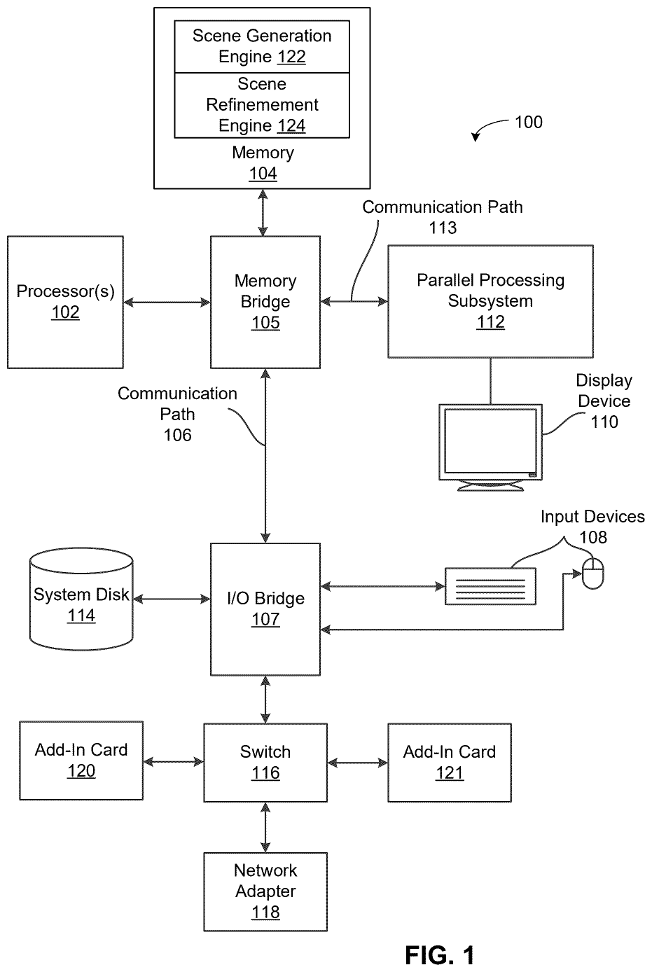

FIG. 1 is a block diagram illustrating a computing system 100 configured to implement one or more aspects of at least one embodiment. In at least one embodiment, computing system 100 may include any type of computing device, including, without limitation, a server machine, a server platform, a desktop machine, a laptop machine, a hand-held/mobile device, a digital kiosk, an in-vehicle infotainment system, a smart speaker or display, a television, and/or a wearable device. In at least one embodiment, computing system 100 is a server machine operating in a data center or a cloud computing environment that provides scalable computing resources as a service over a network.

In various embodiments, computing system 100 includes, without limitation, one or more processors 102 and one or more memories 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In one embodiment, I/O bridge 107 is configured to receive user input information from optional input devices 108, such as (but not limited to) a keyboard, mouse, touch screen, sensor data analysis (e.g., evaluating gestures, speech, or other information about one or more uses in a field of view or sensory field of one or more sensors), a VR/MR/AR headset, a gesture recognition system, a steering wheel, mechanical, digital, or touch sensitive buttons or input components, and/or a microphone, and forward the input information to processor(s) 102 for processing. In at least one embodiment, computing system 100 may be a server machine in a cloud computing environment. In such embodiments, computing system 100 may omit input devices 108 and receive equivalent input information as commands (e.g., responsive to one or more inputs from a remote computing device) and/or messages transmitted over a network and received via the network adapter 118. In at least one embodiment, switch 116 is configured to provide connections between I/O bridge 107 and other components of computing system 100, such as a network adapter 118 and various add-in cards 120 and 121.

In at least one embodiment, I/O bridge 107 is coupled to a system disk 114 that may be configured to store content and applications and data for use by processor(s) 102 and parallel processing subsystem 112. In one embodiment, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computing system 100, may be implemented using any technically suitable protocols, including, without limitation, AGP (Accelerated Graphics Port), HyperTransport, or any other bus or point-to-point communication protocol known in the art.

In at least one embodiment, parallel processing subsystem 112 includes a graphics subsystem that delivers pixels to an optional display device 110 that may be any conventional cathode ray tube, liquid crystal display, light-emitting diode display, and/or the like. In such embodiments, parallel processing subsystem 112 may incorporate circuitry optimized for graphics and video processing, including, for example, video output circuitry. Such circuitry may be incorporated across one or more parallel processing units (PPUs), also referred to herein as parallel processors, included within the parallel processing subsystem 112.

In at least one embodiment, parallel processing subsystem 112 incorporates circuitry optimized (e.g., that undergoes optimization) for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and/or compute processing operations. Memor(ies) 104 include at least one device driver configured to manage the processing operations of the one or more PPUs within parallel processing subsystem 112. In addition, memor(ies) 104 include instructions implementing a scene generation engine 122 and a scene refinement engine 124, which can be executed by processor(s) and/or parallel processing subsystem 112.

In various embodiments, parallel processing subsystem 112 may be integrated with one or more of the other elements of FIG. 1 to form a single system. For example, parallel processing subsystem 112 may be integrated with processor(s) 102 and other connection circuitry on a single chip to form a system on a chip (SoC).

Processor(s) 102 may include any suitable processor implemented as a central processing unit (CPU), a graphics processing unit (GPU), an application-specific integrated circuit (ASIC), a field programmable gate array (FPGA), an artificial intelligence (AI) accelerator, a deep learning accelerator (DLA), a parallel processing unit (PPU), a data processing unit (DPU), a vector or vision processing unit (VPU), a programmable vision accelerator (PVA) (which may include one or more VPUs, pixel processing engines (PPEs), and/or direct memory access (DMA) systems), any other type of processing unit, or a combination of different processing units, such as a CPU(s) configured to operate in conjunction with a GPU(s). In general, processor(s) 102 may include any technically feasible hardware unit capable of processing data and/or executing software applications. Further, in the context of this disclosure, the computing elements shown in computing system 100 may correspond to a physical computing system (e.g., a system in a data center or a machine) and/or may correspond to a virtual computing instance executing within a computing cloud.

In at least one embodiment, processor(s) 102 issue commands that control the operation of PPUs. In at least one embodiment, communication path 113 is a Peripheral Component Interconnect Express (PCIe) link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processors 102, and the number of parallel processing subsystems 112, may be modified as desired. For example, in at least one embodiment, memor(ies) 104 may be connected to processor(s) 102 directly rather than through memory bridge 105, and other devices may communicate with memor(ies) 104 via memory bridge 105 and processors 102. In other embodiments, parallel processing subsystem 112 may be connected to I/O bridge 107 or directly to processor(s) 102, rather than to memory bridge 105. In still other embodiments, I/O bridge 107 and memory bridge 105 may be integrated into a single chip instead of existing as one or more discrete devices. In certain embodiments, one or more components shown in FIG. 1 may not be present. For example, switch 116 may be eliminated, and network adapter 118 and add-in cards 120, 121 would connect directly to I/O bridge 107. Further, in certain embodiments, one or more components shown in FIG. 1 may be implemented as virtualized resources in a virtual computing environment, such as a cloud computing environment. In particular, the parallel processing subsystem 112 may be implemented as a virtualized parallel processing subsystem in at least one embodiment. For example, the parallel processing subsystem 112 may be implemented as a virtual graphics processing unit(s) (vGPU(s)) that renders graphics on a virtual machine(s) (VM(s)) executing on a server machine(s) whose GPU(s) and other physical resources are shared across one or more VMs.

### Text-Based Scene Generation Using Language and Visual Artificial Intelligence Models

As discussed, generative artificial intelligence models can be used to generate three-dimensional scene data that can be used to train machine learning models to control interactions in a real-world environment (e.g., to control autonomous vehicles or robots to determine a path of motion for a vehicle or robot to avoid conflicts between other objects along the path of motion). Generally, three-dimensional scene data generated for training these machine learning models may need to reflect realistic three-dimensional environments and obey various physical constraints on the arrangement of objects in an environment. If the three-dimensional scenes generated by a generative model are not sufficiently diverse, the models trained using these scenes may not be able to generalize across different arrangements of objects and thus may be restricted to operating in environments in which objects are arranged in a particular manner (e.g., with objects being organized either parallel with each other or perpendicular with each other). If the three-dimensional scenes generated by a generative model do not comply with physical constraints on the arrangement of objects in an environment, the models trained using these scenes may not work.

To allow for the generation of realistic scenes that comply with rules defining physical constraints on the arrangement of objects in an environment, embodiments of the present disclosure generate scenes using text models that upsample a prompt into a more detailed prompt that defines the objects in a scene and the arrangement of objects in the scene. The upsampled prompt may then be used to generate an intermediate image that conditions the generation of a scene. Using the intermediate image and the relationships between objects defined in the upsampled prompt, a scene graph can be used to graphically define relationships between objects in the scene. The scene graph can be modified to adjust the locations of objects in the scene (e.g., rotationally) so that spatially complex, diverse, and physically plausible scenes are generated. By doing so, embodiments of the present disclosure may allow for the generation of a diverse range of scenes that can be used to train a machine learning model to perform inferencing over a wide variety of scenes. The resulting machine learning model may be a model that can thus generalize over a variety of environments, thus improving the ability of autonomous vehicles, robots, and other autonomous systems to operate in a variety of known and unknown environments.

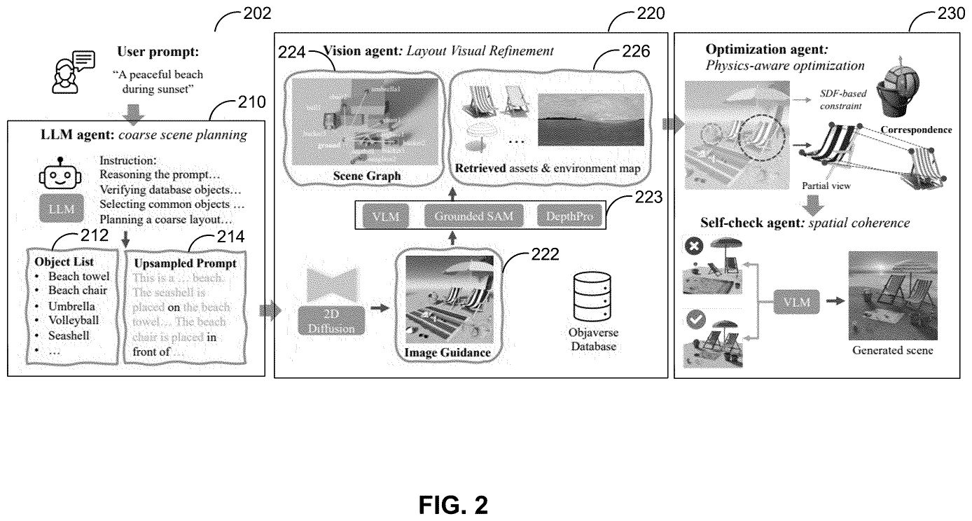

FIG. 2 illustrates a pipeline 200 for generating realistic and physically plausible three-dimensional scenes based on a language model and a visual model, according to at least one embodiment. Pipeline 200 may execute, for example, on one or both of scene generation engine 122 and/or scene refinement engine 124 illustrated in FIG. 1.

To generate a three-dimensional scene, as illustrated, pipeline 200 begins with the input of an input prompt 202 into a language model 210. Generally, language model 210 may be a large language model, a small language model, or other model that ingests a textual input prompt and outputs a textual response to the input prompt. The output of language model 210 may be a textual output that is predictively generated by the language model 210 based on words or concepts that are related to words or concepts included in the input prompt 202. As discussed, input prompt 202 generally specifies, at a high level, a scene to be generated using the pipeline 200. For example, as illustrated in FIG. 2, input prompt 202 specifies that pipeline 200 is to generate “a peaceful beach during sunset.”

Language model 210 ingests the input prompt 202 and generates a plan to generate the scene specified in input prompt 202. To do so, language model 210 generates an object list 212 based on the input prompt 202. In various embodiments, the object list 212 includes objects that are semantically related to the scene described in the input prompt. For example, in the beach scene example illustrated in FIG. 2, the object list 212 includes objects such as a beach towel, a beach chair, an umbrella, a volleyball, a seashell, and other objects that are typically present in a beach scene. Because language model 210 is trained to generate a textual response that is logically relevant to the scene described in input prompt 202, language model 210 may generate an object list 212 that does not include objects that would not be relevant to the scene described in input prompt 202, such as a set of skis, winter clothing, or the like.

Based on the input prompt 202 and object list 212, language model 210 generates an upsampled prompt 214 that describes the scene to be generated using pipeline 200 in further detail. Generally, language model 210 can generate the upsampled prompt based on a prompt that instructs language model 210 to generate a coarse description of the scene (e.g., the environment in which objects in object list 212 are to be placed) and relationships between different objects in object list 212. This upsampled prompt 214 includes additional detail relative to input prompt 202 that a vision agent 220 can use to generate an image of a scene that can be used to guide the final generation of the scene specified in input prompt 202. For example, while input prompt 202 specifies that the requested scene is “a peaceful beach during sunset,” upsampled prompt 214 may specify that the environment in which objects are to be placed is a beach during sunset and may specify the objects to be included in the generated scene. The objects listed in upsampled prompt 214 may be drawn from object list 212 and may include spatial or positional relationships between different objects in object list 212. For example, the upsampled prompt may specify that a first object in object list 212 is positioned on top of a second object in object list 212, that different objects are adjacent to each other, or the like.

In some embodiments, language model 210 selects an object from object list 212 as an anchor object. The anchor object may be an object based on which other objects are arranged. Conceptually, if objects are arranged in a tree hierarchy, the anchor object may be the object at the highest level of the tree (e.g., a root node, if the scene itself is not considered an object in the tree, or the highest non-scene node in the tree if the scene itself is considered an object in the tree).

In some embodiments, input prompt 202 may be a detailed prompt that already includes information about the objects included in the scene and the relationships between these objects. In such a case, language model 210 need not be invoked to upsample input prompt 202 into a more detailed form.

Vision agent 220 uses the upsampled prompt 214 generated by language model 210 (or, in some embodiments, input prompt 202 itself) to generate a guidance image 222 (or other intermediate image) that represents a plausible arrangement of objects in the scene. The guidance image 222 may serve as a starting point for generating the final output image as a response to the input prompt 202. Generally, vision agent 220 may use a diffusion model or other image generation model that generates an image conforming to an input prompt based on encoding object functionality and spatial relationships learned from common co-occurrences of objects and spatial arrangements of objects in large-scale image datasets. In some embodiments, guidance image 222 may be a three-dimensional image based upon which spatial relationships and object functionality are defined. These spatial relationships may include, for example, object adjajencies, object hierarchies, distances between objects, depth in a three-dimensional scene, and the like.

Based on the guidance image 222, vision agent 220 generates a scene graph 224 representing the objects in the guidance image 222 and the spatial or structural relationships between these objects using one or more image processing models 223. The image processing models 223 include a vision language model (VLM) that generates a description of an image, a segmentation model (labeled “Grounded SAM”) that segments guidance image 222 into different segments corresponding to different objects in the image, and a depth model (labeled “DepthPro”) that can generate a depth map illustrating the distance of objects in guidance image 222 relative to a reference point or plane. Generally, vision agent 220 generates the scene graph 224 using image processing models 223 based on semantically segmenting the guidance image 222 into the constituent objects contained therein. In doing so, one or more of the image processing models 223 (e.g., the segmentation model) can identify different objects in the guidance image 222 and generate three-dimensional bounding boxes around these objects. These three-dimensional bounding boxes in scene graph 224 may, in some embodiments, allow for 5 degrees of freedom (5DOF) adjustment of the positioning of an object in the scene. Generally, 5DOF movement allows for an object to be moved in up to five independent directions: three translational directions (along the width, depth, and height dimensions and two rotational directions (roll, yaw). In some embodiments, additional axes of motion (e.g., pitch) may be contemplated.

In some embodiments, vision agent 220 can initialize scene graph 224 based on semantically segmenting the guidance image 222 into a plurality of segments via the segmentation model of the one or more image processing models 223, with each segment corresponding to an instance of an object. Different segments may be assigned to different nodes in scene graph 224 based on relationships between the object and a defined anchor object for the scene depicted in the guidance image 222. In some embodiments, scene graph 224 may be structured as a graph of bounding boxes, where each bounding box is associated with an object and has a defined size and centroid based on which adjustments are applied to the object associated with the bounding box. Vision agent 220 can generate the arrangement of bounding boxes (and thus objects) in the scene graph 224, for example, based on a depth estimation model in the one or more imaging processing models 223 that generate a depth map for the scene. The depth map generally provides information about the depthwise distance of different objects in the scene relative to a reference plane (e.g., a focal plane of a virtual camera used to view the scene) and can be used to determine the relative locations of different objects in the scene for generating scene graph 224. Generally, within scene graph 224, vision agent 220 can place objects nearer to the reference plane in front of objects that are further away from the reference plane. In some embodiments, the depth map may be used to generate a three-dimensional point cloud based on which scene graph 224 is generated. The three-dimensional point cloud may incorporate depth data into the point cloud to illustrate the locations of different objects in the scene, as well as spatial relationships between different objects in the scene.

The resulting scene graph 224 generally represents a coarse estimate of the locations of objects in the scene generated using pipeline 200. However, due to occlusion of objects in a scene, limited perspectives from which scenes are generated, and segmentation errors that may result in objects being segmented incorrectly, and the like, the scene graph 224 generally does not represent the final arrangement of objects in the scene. For example, while the scene graph 224 may generally represent roughly accurate locations of objects in a graph, various fine adjustments may need to be made to the positions of objects in the scene in order for the scene to comply with rules defining valid and invalid scenes. Thus, vision agent 220 can generate a collection of visual assets 226 associated with the objects in object list 212 defined by language model 210, including an environment map in which the objects in object list 212 are to be overlaid. Generally, vision agent 220 can generate the collection of visual assets 226 based on retrieving visual assets associated with the objects in object list 212 from one or more databases in which three-dimensional models of these visual assets are stored. By doing so, embodiments of the present disclosure may allow for independent modification of the positioning of objects, instead of the generation of a monolithic scene in which objects are integral to the scene and cannot be adjusted after the scene is generated. Fine adjustments may be made to the scene graph 224 prior to inserting the visual assets associated with the objects in object list 212 into the bounding boxes in scene graph 224. In some embodiments, pipeline 200 focuses on the positioning of objects in the scene using the scene graph 224, and the background of the scene may be set by the environment map.

Scene optimization engine 230 adjusts the layout of objects in the scene based on applying various adjustments to the bounding boxes associated with the objects to account for occlusions from incomplete point clouds that lead to errors in object orientation, scale, and position, and discrepancies between the collection of visual assets 226 and image guidance. Scene optimization engine 230 can perform physics-aware adjustments to the layout of the scene as well as spatial coherence-based adjustments to the layout of the scene to ensure that a generated scene is realistic and complies with various physics and other real-world rules on object interaction. A physics-aware adjustment to the layout of a scene accounts for physical realities of how objects can interact with each other in the real world, such as compliance with Newtonian physics, the observation that no two objects can occupy the same space at the same time, and the like. Spatial coherence-based adjustments to the layout of a scene account for common-sense intuitions on how a scene should look and the arrangement of objects in a scene. For example, a coherence-based adjustment for the beach scene discussed herein with respect to FIG. 2 may specify that the beach chairs in a generated scene are to be placed facing the beach towel and not facing away from the beach towel, as a placement of the beach chairs facing away from the beach towel would not be a typical way these objects would be arranged in the real world.

In one example, physics-aware adjustments to a scene can include adjustments that compensate for pose estimation errors in a scene, or errors in the position and orientation of objects in a scene. To adjust for pose estimation errors, scene optimization engine 230 can attempt to match N points between a rendered object and partially visible regions in the guidance image 222 in a two-dimensional space. For an image I including N objects, each represented by o and defined by a 5DOF configuration including scale s, upright rotation R, and translation T=(tₓ, t_{y}, t_{z}), and a counterpart object õ in a guidance image Ĩ, an objective for ensuring visual coherence may be defined as a minimization of a distance between corresponding points based on an optimization of 5DOF parameters. Thus, a matching process between points associated with o and õ may be defined by the equation:

$${\{ p ( x , y ) , \tilde{p} ( x , y ) \}}_{i}^{m} = RoMa ( o , \tilde{o} )$$

where p(x,y) and \tilde{p}(x,y) are correspondent pairs in objects o and õ, respectively. Given m points in each optimization iteration with a confidence score exceeding a threshold score, the loss to be minimized, which may be based on the two-dimensional pixel distance and three-dimensional project point cloud distance between p(x,y) and \tilde{p}(x,y), may be represented by the equation:

$${ℒ}_{pose} = {λ}_{2 d} {ℒ}_{2 d} + {λ}_{3 d} {ℒ}_{3 d}$$

where λ_{2d} and λ_{3d} are coefficients of the two-dimensional pixel loss [symbol] ₂d and three-dimensional point cloud loss [symbol] _{3d}, respectively.

Scene optimization engine 230 can also perform various adjustments to ensure the physical plausibility of the arrangement of objects in object list 212 in the scene generated using pipeline 200. Generally, real-world scenes obey certain physical constraints, such as the placement of objects such that stability is maintained on contact surfaces and such that objects do not intersect with each other. To allow for scenes to be generated with complex inter-object relationships, scene optimization engine 230 uses signed distance fields (SDFs) instead of three-dimensional bounding boxes to allow for object geometry representation while supporting accurate collision detection and object stability constraints. To do so, scene optimization engine 230 generates an SDF-based physical structure based on the scene graph 224 generated by vision agent 220. That is, scene optimization engine 230 can generate an SDF-based physical structure starting from an anchor object and followed by subsequent children objects in scene graph 224. To do so, given a scene graph with N objects and with each object having a 5DOF configuration including scale s, upright rotation R, and translation T=(tₓ, t_{y}, t_{z}), n points may be sampled from a surface mesh of an object. Scene optimization engine 230 can use the sampled n points to compute a centroid for an object, based on which objects can be subsequently moved.

As discussed, one physical constraint on the arrangement of objects in a scene may be a collision constraint in which objects may not collide with each other. To determine whether a collision constraint is violated, scene optimization engine 230 uses a position collision loss [symbol] ₜᵣₐₙₛₗₐₜᵢₒₙ and a scale collision loss [symbol] _{scale}. The deviation caused by collisions that impact translation T may be defined according to the equation:

$${ℒ}_{translation} = {‖ f ( T , \vert d \vert , u ) - T ‖}_{2}^{2}$$

where f(T,d,u)=T+u·|d| computes a collision-free position \hat{T} by adjusting T along direction u with step size d. In this equation, d is the negative SDF value at a collision point vᵢ. The direction u is defined from the collision point toward the model's centroid C, guiding objects away from collisions.

The scale of objects may be affected by collisions as well. The scale loss caused by collisions due to scale issues may be defined according to the equation:

$${ℒ}_{scale} = \{ \begin{matrix}{‖ g ( \vert d \vert , u ) - s ‖}_{2}^{2} & if {N}_{classes} > 1 \\ 0 & otherwise\end{matrix}$$

where

$$g ( \vert d \vert , u ) = \frac{u - \vert d \vert}{u}$$

defines the target scale s to reduce collision regions. N_{classes} denotes the number of clusters formed from detected negative SDF points on the object surface. Generally, when surface points a and b with d(vₐ)≤0 and d(v_{b})≤0 belong to different clusters, the scale of an object may be diminished.

In some embodiments, another constraint on the location of objects in a scene may be a stability constraint. Generally, in the real world, objects are acted upon by gravity, with the bottom points of an object contacting the surface on which the object is positioned (e.g., an object's parent object) absent some force lifting the object away from the surface. To enforce stability constraints on objects in a scene, scene optimization engine 230 can enforce contact between the bottom points of an object and the surface of the parent object, such that the SDF values of the bottom points of the object relative to its parent object is 0. The stability loss to be minimized, or at least reduced, to ensure that the stability constraint is met may be defined according to the equation:

$${ℒ}_{stability} = 1 - exp ( - \sum {( d ( {v}_{k} ) )}^{2} )$$

where vₖ represents the bottom points of an object, and d(vₖ) are the SDF values for the bottom points vₖ.

In some embodiments, scene optimization engine 230 can optimize the positions of objects in a scene jointly. To do so, a joint loss function may be defined as:

$$ℒ = {λ}_{p} {ℒ}_{pose} + {λ}_{cT} {ℒ}_{translation} + {λ}_{cS} {ℒ}_{scale} + {λ}_{s} {ℒ}_{stability}$$

The weighting factors λₚ, λ_{cT}, and λₛ may be parameters learned based on the description of a scene using a vision language model. These weighting factors control the influence of pose errors, translation errors, and stability errors in determining an overall loss value that is used to modify the arrangement of objects in the image depicting the scene specified in prompt 202.

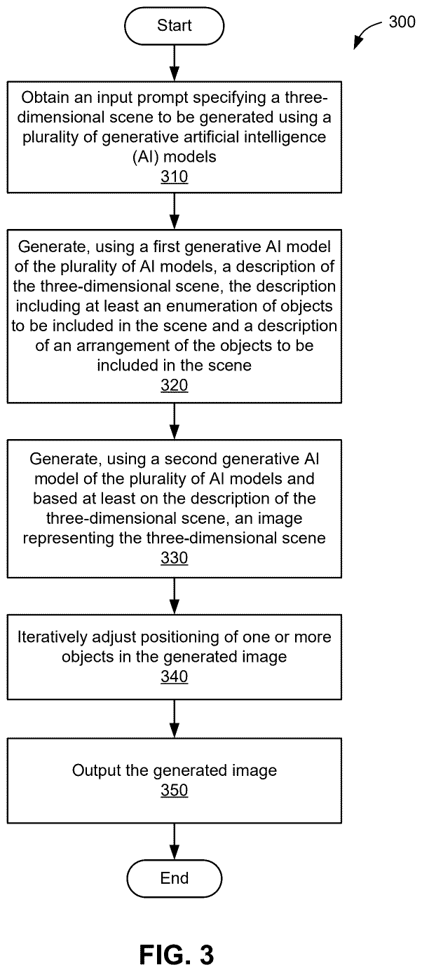

FIG. 3 illustrates example operations 300 for generating realistic and physically plausible three-dimensional scenes based on a language model and a visual model, according to at least one embodiment. Operations 300 may be performed, for example, by a system on which scene generation engine 122 and scene refinement engine 124 execute, such as system 100 illustrated in FIG. 1.

As illustrated, operations 300 begin at block 310, with scene generation engine 122 obtaining an input prompt specifying a three-dimensional scene to be generated using a plurality of generative artificial intelligence models. In some embodiments, the input prompt may broadly specify the three-dimensional scene to be generated using one or more generative artificial intelligence models and may not explicitly define the objects included in the scene. In some embodiments, the input prompt may be more detailed and may specify both the three-dimensional scene to be generated and the objects to be included in the scene. In some embodiments, the input prompt may further include information about spatial relationships between different objects to be included in the scene.

At block 320, scene generation engine 122 generates, using a first generative artificial intelligence model (e.g., the language model 210 illustrated in FIG. 2) of the plurality of generative artificial intelligence models, a description of the three-dimensional scene. Generally, the description including at least an enumeration of objects to be included in the scene and a description of an arrangement of the objects to be included in the scene.

In some embodiments, scene generation engine 122 can generate the description of the three-dimensional scene based on executing a first prompt generated based on the input prompt using the first generative artificial intelligence model to enumerate the objects to the included in the scene. Generally, the first prompt may specify that the first generative artificial intelligence model is to enumerate the objects based on objects commonly included in the scene (e.g., as learned from a data set or other corpus of training data). Scene generation engine 122 can execute a second prompt generated based on the input prompt and the enumeration of the objects to be included in the scene to generate the description of the arrangement of objects. Generally, the second prompt may specify relationships between the objects to be included in the scene or may request that the first generative artificial intelligence model generate these relationships. In some embodiments, the enumeration of the objects to be included in the scene comprises an object designated as an anchor object based on which other objects in the scene are arranged. As discussed, other objects in the scene may generally be defined in relationship or with reference to the anchor object (e.g., a sibling objects, as child objects having a direct spatial relationship with the anchor object, as indirect children having a spatial relationship with the anchor object through one or more other objects, etc.).

In some embodiments, the description of the three-dimensional scene comprises an upsampled version of the input prompt. For example, for an input prompt that broadly specifies the scene to be generated, the description of the three-dimensional scene may include information not included in the input prompt but generated by a language model that expands the input prompt. This information may include information about objects to be rendered in the scene, relationships between different objects, and the like.

At block 330, scene generation engine 122 generates, using a second generative artificial intelligence model (e.g., the vision agent 220 illustrated in FIG. 2) of the plurality of generative artificial intelligence models and based on at least the description of the three-dimensional scene, an image representing the three-dimensional scene.

In some embodiments, to generate the image representing the three-dimensional scene, scene generation engine 122 can use the second generative artificial intelligence model and the description of the three-dimensional scene to generate a guidance image representing the three-dimensional scene. Using the second generative artificial intelligence model, the description of the three-dimensional scene, and the guidance image, scene generation engine 122 can use the second generative artificial intelligence model to generate a graph representation of objects in the three-dimensional scene.

In some embodiments, the graph representation of objects in the three-dimensional scene comprise a graph in which a position of each object in the scene is manipulable along a plurality of axes in a three-dimensional space. For example, the graph representation of objects may be a graph of bounding boxes or other representations of objects that are manipulable in any of a plurality of degrees of freedom (e.g., 5DOF).

At block 340, scene generation engine 122 and/or scene refinement engine 124 iteratively adjusts positioning of one or more objects in the generated image.

In some embodiments, scene generation engine 122 can further construct a signed distance field (SDF) for the objects in the three-dimensional scene. To iteratively adjust the positioning of the one or more objects in the generated image, scene generation engine 122 and/or scene refinement engine 124 can do so based on sampling a plurality of points in the SDF for the one or more objects. The adjustments may be performed based, for example, on a collision loss between SDF points for the objects in the three-dimensional scene. Generally, the collision loss may be configured to move objects away from a negative SDF value and towards a centroid of the three-dimensional scene. In some embodiments, scene generation engine 122 and/or scene refinement engine 124 may be configured to iteratively adjust the positioning of the one or more objects based on a stability constraint associated with values of SDF points for defined reference points relative to a surface on which an object rests for each of the one or more objects. Generally, the stability constraint may push values of SDF points for these defined reference points to a value of 0 for objects that are in contact via gravity with another object.

At block 350, scene generation engine 122 and/or scene refinement engine 124 outputs the generated image including the adjusted positioning of the one or more objects.

In some embodiments, the one or more objects comprise visual assets retrieved from a database. Generally, the visual assets may be insertable into a base image as independently manipulable objects. As discussed, these visual assets may be manipulated in terms of size, scale, and/or positioning along any of a plurality of degrees of freedom. In some embodiments, the base image comprises an environment map selected from a database based on the description of the scene.

### Inference and Training Logic

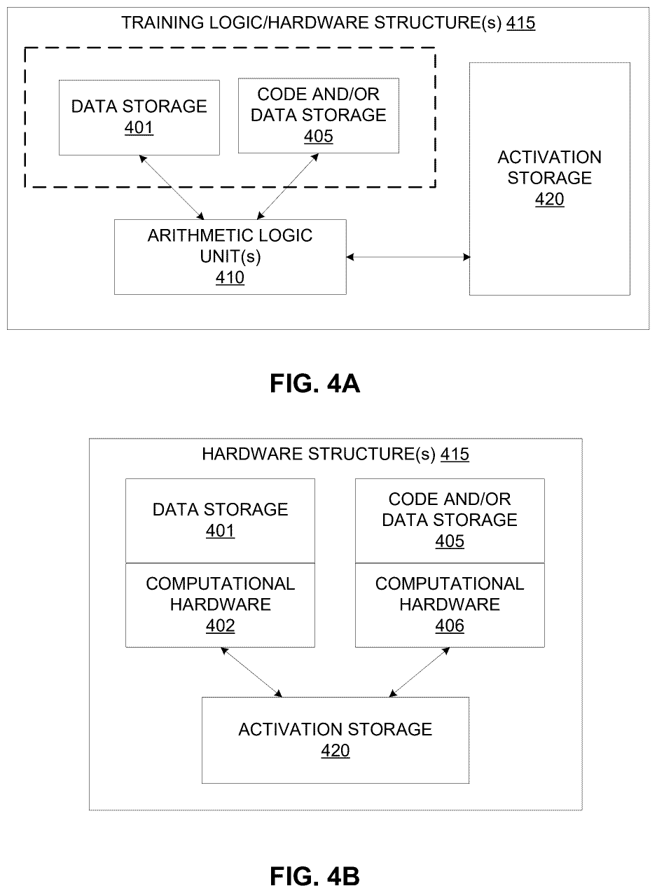

FIG. 4A illustrates inference and/or training logic 415 used to perform inferencing and/or training operations associated with one or more embodiments. Details regarding inference and/or training logic 415 are provided herein in conjunction with at least FIGS. 4A and/or 4B.

In at least one embodiment, inference and/or training logic 415 may include, without limitation, code and/or data storage 401 to store forward and/or output weight and/or input/output data, and/or other parameters to configure neurons or layers of a neural network trained and/or used for inferencing in aspects of one or more embodiments. In at least one embodiment, training logic 415 may include, or be coupled to code and/or data storage 401 to store graph code or other software to control timing and/or order, in which weight and/or other parameter information is to be loaded to configure, logic, including integer and/or floating point units (collectively, arithmetic logic units (ALUs)). In at least one embodiment, code, such as graph code, loads weight or other parameter information into processor ALUs based on an architecture of a neural network to which such code corresponds. In at least one embodiment, code and/or data storage 401 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 401 may be included with other on-chip or off-chip data storage, including a processor's L1, L2, or L3 cache or system memory.

In at least one embodiment, any portion of code and/or data storage 401 may be internal or external to one or more processors or other hardware logic devices or circuits. In at least one embodiment, code and/or code and/or data storage 401 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 401 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 415 may include, without limitation, a code and/or data storage 405 to store backward and/or output weight and/or input/output data corresponding to neurons or layers of a neural network trained and/or used for inferencing in aspects of one or more embodiments. In at least one embodiment, code and/or data storage 405 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 415 may include, or be coupled to code and/or data storage 405 to store graph code or other software to control timing and/or order, in which weight and/or other parameter information is to be loaded to configure, logic, including integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of code and/or data storage 405 may be included with other on-chip or off-chip data storage, including a processor's L1, L2, or L3 cache or system memory. In at least one embodiment, any portion of code and/or data storage 405 may be internal or external to one or more processors or other hardware logic devices or circuits. In at least one embodiment, code and/or data storage 405 may be cache memory, DRAM, SRAM, non-volatile memory (e.g., flash memory), or other storage. In at least one embodiment, a choice of whether code and/or data storage 405 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 401 and code and/or data storage 405 may be separate storage structures. In at least one embodiment, code and/or data storage 401 and code and/or data storage 405 may be a combined storage structure. In at least one embodiment, code and/or data storage 401 and code and/or data storage 405 may be partially combined and partially separate. In at least one embodiment, any portion of code and/or data storage 401 and code and/or data storage 405 may be included with other on-chip or off-chip data storage, including a processor's L1, L2, or L3 cache or system memory.

In at least one embodiment, inference and/or training logic 415 may include, without limitation, one or more arithmetic logic unit(s) (“ALU(s)”) 410, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 420 that are functions of input/output and/or weight parameter data stored in code and/or data storage 401 and/or code and/or data storage 405. In at least one embodiment, activations stored in activation storage 420 are generated according to linear algebraic and or matrix-based mathematics performed by ALU(s) 410 in response to performing instructions or other code, wherein weight values stored in code and/or data storage 405 and/or data storage 401 are used as operands along with other values, such as bias values, gradient information, momentum values, or other parameters or hyperparameters, any or all of which may be stored in code and/or data storage 405 or code and/or data storage 401 or another storage on or off-chip.

In at least one embodiment, ALU(s) 410 are included within one or more processors or other hardware logic devices or circuits, whereas in another embodiment, ALU(s) 410 may be external to a processor or other hardware logic device or circuit that uses them (e.g., a co-processor). In at least one embodiment, ALUs 410 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 401, code and/or data storage 405, and activation storage 420 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 420 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 420 may be cache memory, DRAM, SRAM, non-volatile memory (e.g., flash memory), or other storage. In at least one embodiment, activation storage 420 may be completely or partially within or external to one or more processors or other logical circuits. In at least one embodiment, a choice of whether activation storage 420 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 415 illustrated in FIG. 4A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 415 illustrated in FIG. 4A may be used in conjunction with central processing unit (“CPU”) hardware, graphics processing unit (“GPU”) hardware or other hardware, such as field programmable gate arrays (“FPGAs”).

FIG. 4B illustrates inference and/or training logic 415, according to at least one embodiment. In at least one embodiment, inference and/or training logic 415 may include, without limitation, hardware logic in which computational resources are dedicated or otherwise exclusively used in conjunction with weight values or other information corresponding to one or more layers of neurons within a neural network. In at least one embodiment, inference and/or training logic 415 illustrated in FIG. 4B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 415 illustrated in FIG. 4B may be used in conjunction with central processing unit (CPU) hardware, graphics processing unit (GPU) hardware or other hardware, such as field programmable gate arrays (FPGAs). In at least one embodiment, inference and/or training logic 415 includes, without limitation, code and/or data storage 401 and code and/or data storage 405, which may be used to store code (e.g., graph code), weight values and/or other information, including bias values, gradient information, momentum values, and/or other parameter or hyperparameter information. In at least one embodiment illustrated in FIG. 4B, each of code and/or data storage 401 and code and/or data storage 405 is associated with a dedicated computational resource, such as computational hardware 402 and computational hardware 406, respectively. In at least one embodiment, each of computational hardware 402 and computational hardware 406 comprises one or more ALUs that perform mathematical functions, such as linear algebraic functions, only on information stored in code and/or data storage 401 and code and/or data storage 405, respectively, result of which is stored in activation storage 420.

In at least one embodiment, each of code and/or data storage 401 and 405 and corresponding computational hardware 402 and 406, respectively, correspond to different layers of a neural network, such that resulting activation from one storage/computational pair 401/402 of code and/or data storage 401 and computational hardware 402 is provided as an input to a next storage/computational pair 405/406 of code and/or data storage 405 and computational hardware 406, in order to mirror a conceptual organization of a neural network. In at least one embodiment, each of storage/computational pairs 401/402 and 405/406 may correspond to more than one neural network layer. In at least one embodiment, additional storage/computation pairs (not shown) subsequent to or in parallel with storage/computation pairs 401/402 and 405/406 may be included in inference and/or training logic 415.

### Neural Network Training and Deployment

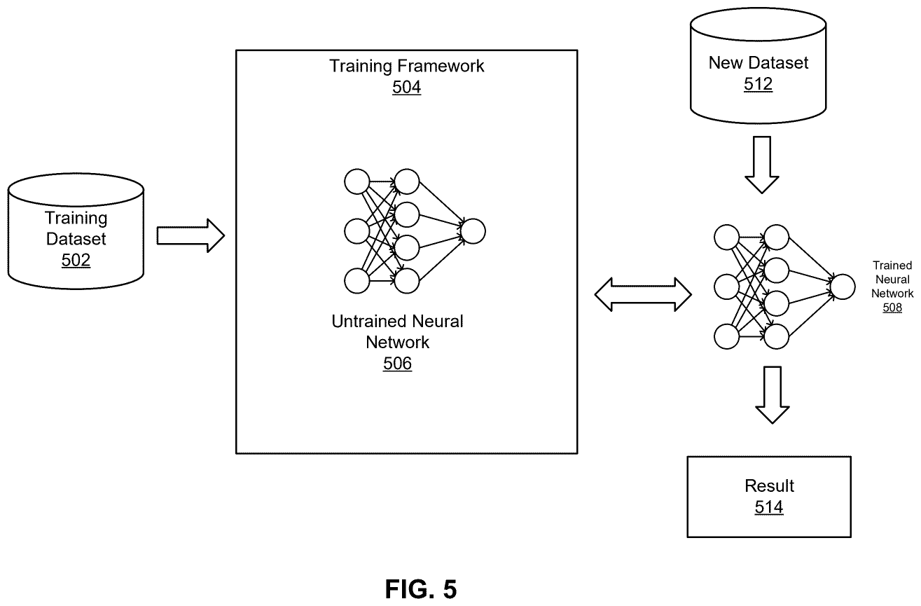

FIG. 5 illustrates training and deployment of a deep neural network, according to at least one embodiment. In at least one embodiment, untrained neural network 506 is trained using a training dataset 502. In at least one embodiment, training framework 504 is a PyTorch framework, whereas in other embodiments, training framework 504 is a TensorFlow, Boost, Caffe, Microsoft Cognitive Toolkit/CNTK, MXNet, Chainer, Keras, Deeplearning4j, or other training framework. In at least one embodiment, training framework 504 trains an untrained neural network 506 and enables it to be trained using processing resources described herein to generate a trained neural network 508. In at least one embodiment, weights may be chosen randomly or by pre-training using a deep belief network. In at least one embodiment, training may be performed in either a supervised, partially supervised, or unsupervised manner.

In at least one embodiment, untrained neural network 506 is trained using supervised learning, wherein training dataset 502 includes an input paired with a desired output for an input, or where training dataset 502 includes input having a known output and an output of neural network 506 is manually graded. In at least one embodiment, untrained neural network 506 is trained in a supervised manner and processes inputs from training dataset 502 and compares resulting outputs against a set of expected or desired outputs. In at least one embodiment, errors are then propagated back through untrained neural network 506. In at least one embodiment, training framework 504 adjusts weights that control untrained neural network 506. In at least one embodiment, training framework 504 includes tools to monitor how well untrained neural network 506 is converging towards a model, such as trained neural network 508, suitable to generating correct answers, such as in result 514, based on input data such as a new dataset 512.

In at least one embodiment, training framework 504 trains untrained neural network 506 repeatedly while adjust weights to refine an output of untrained neural network 506 using a loss function and adjustment algorithm, such as stochastic gradient descent. In at least one embodiment, training framework 504 trains untrained neural network 506 until untrained neural network 506 achieves a desired accuracy. In at least one embodiment, trained neural network 508 can then be deployed to implement any number of machine learning operations.

In at least one embodiment, untrained neural network 506 is trained using unsupervised learning, wherein untrained neural network 506 attempts to train itself using unlabeled data. In at least one embodiment, unsupervised learning training dataset 502 will include input data without any associated output data or “ground truth” data. In at least one embodiment, untrained neural network 506 can learn groupings within training dataset 502 and can determine how individual inputs are related to untrained dataset 502. In at least one embodiment, unsupervised training can be used to generate a self-organizing map in trained neural network 508 capable of performing operations useful in reducing dimensionality of new dataset 512. In at least one embodiment, unsupervised training can also be used to perform anomaly detection, which allows identification of data points in new dataset 512 that deviate from normal patterns of new dataset 512.

In at least one embodiment, semi-supervised learning may be used, which is a technique in which in training dataset 502 includes a mix of labeled and unlabeled data. In at least one embodiment, training framework 504 may be used to perform incremental learning, such as through transferred learning techniques. In at least one embodiment, incremental learning enables trained neural network 508 to adapt to new dataset 512 without forgetting knowledge instilled within trained neural network 508 during initial training.

In at least one embodiment, training framework 504 is a framework processed in connection with a software development toolkit such as an OpenVINO (Open Visual Inference and Neural network Optimization) toolkit. In at least one embodiment, an OpenVINO toolkit is a toolkit such as those developed by Intel Corporation of Santa Clara, CA.

In at least one embodiment, OpenVINO is a toolkit for facilitating development of applications, specifically neural network applications, for various tasks and operations, such as human vision emulation, speech recognition, natural language processing, recommendation systems, and/or variations thereof. In at least one embodiment, OpenVINO supports neural networks such as convolutional neural networks (CNNs), recurrent and/or attention-based neural networks, and/or various other neural network models. In at least one embodiment, OpenVINO supports various software libraries such as OpenCV, OpenCL, and/or variations thereof.

In at least one embodiment, OpenVINO supports neural network models for various tasks and operations, such as classification, segmentation, object detection, face recognition, speech recognition, pose estimation (e.g., humans and/or objects), monocular depth estimation, image inpainting, style transfer, action recognition, colorization, and/or variations thereof.

In at least one embodiment, OpenVINO comprises one or more software tools and/or modules for model optimization, also referred to as a model optimizer. In at least one embodiment, a model optimizer is a command line tool that facilitates transitions between training and deployment of neural network models. In at least one embodiment, a model optimizer optimizes neural network models for execution on various devices and/or processing units, such as a GPU, CPU, PPU, GPGPU, and/or variations thereof. In at least one embodiment, a model optimizer generates an internal representation of a model, and optimizes said model to generate an intermediate representation. In at least one embodiment, a model optimizer reduces a number of layers of a model. In at least one embodiment, a model optimizer removes layers of a model that are utilized for training. In at least one embodiment, a model optimizer performs various neural network operations, such as modifying inputs to a model (e.g., resizing inputs to a model), modifying a size of inputs of a model (e.g., modifying a batch size of a model), modifying a model structure (e.g., modifying layers of a model), normalization, standardization, quantization (e.g., converting weights of a model from a first representation, such as floating point, to a second representation, such as integer), and/or variations thereof.

In at least one embodiment, OpenVINO comprises one or more software libraries for inferencing, also referred to as an inference engine. In at least one embodiment, an inference engine is a C++ library, or any suitable programming language library. In at least one embodiment, an inference engine is utilized to infer input data. In at least one embodiment, an inference engine implements various classes to infer input data and generate one or more results. In at least one embodiment, an inference engine implements one or more API functions to process an intermediate representation, set input and/or output formats, and/or execute a model on one or more devices.

In at least one embodiment, OpenVINO provides various abilities for heterogeneous execution of one or more neural network models. In at least one embodiment, heterogeneous execution, or heterogeneous computing, refers to one or more computing processes and/or systems that utilize one or more types of processors and/or cores. In at least one embodiment, OpenVINO provides various software functions to execute a program on one or more devices. In at least one embodiment, OpenVINO provides various software functions to execute a program and/or portions of a program on different devices. In at least one embodiment, OpenVINO provides various software functions to, for example, run a first portion of code on a CPU and a second portion of code on a GPU and/or FPGA. In at least one embodiment, OpenVINO provides various software functions to execute one or more layers of a neural network on one or more devices (e.g., a first set of layers on a first device, such as a GPU, and a second set of layers on a second device, such as a CPU).

In at least one embodiment, OpenVINO includes various functionality similar to functionalities associated with a CUDA programming model, such as various neural network model operations associated with frameworks such as TensorFlow, PyTorch, and/or variations thereof. In at least one embodiment, one or more CUDA programming model operations are performed using OpenVINO. In at least one embodiment, various systems, methods, and/or techniques described herein are implemented using OpenVINO.

Other variations are within spirit of present disclosure. Thus, while disclosed techniques are susceptible to various modifications and alternative constructions, certain illustrated embodiments thereof are shown in drawings and have been described herein in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

### EXAMPLE CLAUSES

Implementation details of various embodiments of the present disclosure are described in the following numbered clauses:

1. In some embodiments, a method comprises obtaining an input prompt specifying a three-dimensional scene to be generated using a plurality of generative artificial intelligence (AI) models; generating, using a first generative AI model of the plurality of generative AI models, a description of the three-dimensional scene, the description including at least an enumeration of objects to be included in the scene and a description of an arrangement of the objects to be included in the scene; generating, using a second generative AI model of the plurality of generative AI models and based at least on the description of the three-dimensional scene, an image representing the three-dimensional scene; adjusting positioning of one or more objects in the generated image; and outputting the generated image including the adjusted positioning of the one or more objects.

2. The method of clause 1, wherein generating the description of the three-dimensional scene comprises: executing a first prompt generated based on the input prompt using the first generative AI model to enumerate the objects to the included in the scene, the first prompt specifying that the first generative AI model is to enumerate the objects based on objects commonly included in the scene; and executing a second prompt generated based on the input prompt and the enumeration of the objects to be included in the scene to generate the description of the arrangement of objects, the second prompt specifying relationships between the objects to be included in the scene.

3. The method of clause 2, wherein the enumeration of the objects to be included in the scene comprises an object designated as an anchor object based on which other objects in the scene are arranged.

4. The method of any of clauses 1 through 3, wherein the description of the three-dimensional scene comprises an upsampled version of the input prompt.

5. The method of any of clauses 1 through 4, wherein generating the image representing the three-dimensional scene comprises: generating, using the second generative AI model and the description of the three-dimensional scene, a guidance image representing the three-dimensional scene; and generating, using the second generative AI model, the description of the three-dimensional scene, and the guidance image, a graph representation of objects in the three-dimensional scene.

6. The method of clause 5, wherein the graph representation of objects in the three-dimensional scene comprise a graph in which a position of each object in the scene is manipulable along a plurality of axes in a three-dimensional space.

7. The method of any of clauses 5 or 6, further comprising constructing a signed distance field (SDF) for the objects in the three-dimensional scene, wherein adjusting the positioning of the one or more objects in the generated image is based on sampling a plurality of points in the SDF for the one or more objects.

8. The method of clause 7, wherein adjusting the positioning of the one or more objects is based on a collision loss between SDF points for the objects in the three-dimensional scene, the collision loss being configured to move objects away from a negative SDF value and towards a centroid of the three-dimensional scene.

9. The method of any of clauses 7 or 8, adjusting the positioning of the one or more objects is based on a stability constraint associated with values of SDF points for defined reference points relative to a surface on which an object rests for each of the one or more objects.

10. The method of any of clauses 1 through 9, wherein the one or more objects comprise visual assets retrieved from a database, the visual assets being insertable into a base image as independently manipulable objects.

11. The method of clause 10, wherein the base image comprises an environment map selected from a database based on the description of the scene.

12. A processing system, comprising: at least one memory having executable instructions stored thereon; and one or more processors configured to execute the operations of any of clauses 1 through 11.

13. A processing system, comprising means for performing the operations of any of clauses 1 through 11.

14. A non-transitory computer readable medium having executable instructions stored thereon which, when executed by one or more processors, performs the operations of any of clauses 1 through 11.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A processor-implemented method, comprising:
obtaining an input prompt specifying a three-dimensional scene to be generated using a plurality of generative artificial intelligence (AI) models;
generating a description of the three-dimensional scene using a first generative AI model of the plurality of generative AI models, the description including at least an enumeration of objects and an arrangement of the objects to be included in the scene;
generating, using a second generative AI model of the plurality of generative AI models and based at least on the description of the three-dimensional scene, an image representing the three-dimensional scene;
adjusting positioning of one or more objects in the generated image; and
outputting the generated image including the adjusted positioning of the one or more objects.

2. The method of claim 1, wherein generating the description of the three-dimensional scene comprises:
executing a first prompt generated based on the input prompt using the first generative AI model to enumerate the objects to the included in the scene, the first prompt specifying that the first generative AI model is to enumerate the objects based on a representation of objects commonly included in the scene; and
executing a second prompt generated based on the input prompt and the enumeration of the objects to be included in the scene to generate a description of the arrangement of objects, the second prompt specifying relationships between the objects to be included in the scene.

3. The method of claim 2, wherein the enumeration of the objects to be included in the scene comprises an object designated as an anchor object based on which other objects in the scene are arranged.

4. The method of claim 1, wherein the description of the three-dimensional scene comprises an upsampled version of the input prompt.

5. The method of claim 1, wherein generating the image representing the three-dimensional scene comprises:
generating, using the second generative AI model and the description of the three-dimensional scene, a guidance image representing the three-dimensional scene; and
generating, using the second generative AI model, the description of the three-dimensional scene, and the guidance image, a graph representation of objects in the three-dimensional scene.

6. The method of claim 5, wherein the graph representation of objects in the three-dimensional scene comprises a graph in which a position of at least one object in the scene is manipulable along a plurality of axes in a three-dimensional space.

7. The method of claim 5, further comprising constructing a signed distance field (SDF) for one or more of the objects in the three-dimensional scene, wherein adjusting the positioning of the one or more objects in the generated image is based on sampling a plurality of points in the SDF for the one or more objects.

8. The method of claim 7, wherein adjusting the positioning of the one or more objects is based on a collision loss between SDF points for the objects in the three-dimensional scene, the collision loss being configured to move objects away from a negative SDF value and towards a centroid of the three-dimensional scene.

9. The method of claim 7, wherein adjusting the positioning of the one or more objects is based on a stability constraint associated with values of SDF points for defined reference points relative to a surface on which an object rests for at least one object of the one or more objects.

10. The method of claim 1, wherein the one or more objects comprise visual assets retrieved from a database, the visual assets being insertable into a base image as independently manipulable objects.

11. The method of claim 10, wherein the base image comprises an environment map selected from a plurality of environment maps based on the description of the scene.

12. A processing system, comprising:
circuitry to:
obtain an input prompt specifying a three-dimensional scene to be generated using a plurality of generative artificial intelligence (AI) models;
generate a description of the three-dimensional scene using a first generative AI model of the plurality of generative AI models, the description including at least an enumeration of objects and an arrangement of the objects to be included in the scene;
generate, using a second generative AI model of the plurality of generative AI models and the description of the three-dimensional scene, an image representing the three-dimensional scene;
adjust positioning of one or more objects in the generated image; and
output the generated image including the adjusted positioning of the one or more objects.

13. The processing system of claim 12, wherein to generate the description of the three-dimensional scene, the one or more processors are configured to execute the executable instructions to cause the processing system to:
execute a first prompt generated based on the input prompt using the first generative AI model to enumerate the objects to be included in the scene, the first prompt specifying that the first generative AI model is to enumerate the objects based on a representation of objects commonly included in the scene; and
execute a second prompt generated based on the input prompt and the enumeration of the objects to be included in the scene to generate a description of the arrangement of objects, the second prompt specifying relationships between the objects to be included in the scene.

14. The processing system of claim 13, wherein the enumeration of the objects to be included in the scene comprises an object designated as an anchor object based on which other objects in the scene are arranged.

15. The processing system of claim 12, wherein to generate the image representing the three-dimensional scene, the circuitry is configured to cause the processing system to:
generate, using the second generative AI model and the description of the three-dimensional scene, a guidance image representing the three-dimensional scene; and
generate, using the second generative AI model, the description of the three-dimensional scene, a description of the guidance image, and a graph representation of objects in the three-dimensional scene.

16. The processing system of claim 15, wherein the graph representation of objects in the three-dimensional scene comprises a graph in which a position of at least one object in the scene is manipulable along a plurality of axes in a three-dimensional space.

17. The processing system of claim 15, wherein the circuitry is further configured to cause the processing system to construct a signed distance field (SDF) for the objects in the three-dimensional scene, wherein to adjust the positioning of the one or more objects in the generated image is based on sampling a plurality of points in the SDF for the one or more objects.

18. The processing system of claim 17, wherein adjustments to the positioning of the one or more objects are based on a collision loss between SDF points for the objects in the three-dimensional scene, the collision loss being configured to move objects away from a negative SDF value and towards a centroid of the three-dimensional scene.

19. The processing system of claim 17, wherein adjustments to the positioning of the one or more objects is based on a stability constraint associated with values of SDF points for defined reference points relative to a surface on which an object rests for each of the one or more objects.

20. The processing system of claim 12, wherein the processing system is comprised in at least one of:
a system for performing simulation operations;
a system for performing digital twin operations;
a system for performing collaborative content creation for 3D assets;
a system for performing one or more deep learning operations;
a system implemented using an edge device;
a system for generating or presenting at least one of virtual reality content, augmented reality content, or mixed reality content;
a system implemented using a robot;
a system for performing one or more conversational AI operations;
a system implemented using one or more large language models (LLMs);
a system implemented using one or more small language models (SLMs);
a system implementing one or more vision language models (VLMs);
a system implementing one or more multi modal language models;
a system for generating synthetic data;
a system for performing one or more generative AI operations;
a system incorporating one or more virtual machines (VMs);
a system implemented at least partially in a data center; or
a system implemented at least partially using cloud computing resources.
